(19) United States
(12) Patent Application Publication
(10) Pub. No.: US 2008/0129433 A1
(43) Pub. Date: Jun. 5, 2008

(54) Load-Lifting Magnet

(76) Inventors: Egon Evertz, Solingen (DE); Thomas Benner, Solingen (DE)

Correspondence Address: K.F. ROSS P.C., 5683 RIVERDALE AVENUE, SUITE 203 BOX 900, BRONX, NY, 10471-0900, US

(21) Appl. No.: 11/666,744

(22) PCT Filed: Sep. 30, 2006
(86) PCT No.: PCT/DE06/01738

§ 371 Date: Apr. 30, 2007

(30) Foreign Application Priority Data
Oct. 31, 2005 (DE) 10 2005 052 391.9

(51) Int. Cl. H01F 7/20

(52) U.S. Cl. 335/290; 335/291

(57) ABSTRACT

A load-lifting magnet for lifting, turning, and transporting a wound body comprising a soft-magnetic material, in particular a coil, with a plurality of magnetic poles. In accordance with the invention, magnetic poles are arranged at right angles to each other on a common support body so that they can hold both one end face of the wound body as well as the surface and in that the support body has a rotating apparatus that permits 90° rotations of the wound body while it is suspended.

The invention relates to a load-lifting magnet having a plurality of poles for lifting, turning, and transporting a wound body comprising a soft-magnetic material, in particular a coil.

Crane transport of large workpieces made of soft magnetic material such as e.g. ingots, slabs, billets, and coils using load-lifting magnets is very advantageous compared to carrying a load with tongs in that the workpiece being handled can be picked up without damage. This is possible because the magnetic poles can cover a large surface area. Electromagnets also work wear-free and economically and can also provide substantial occupational safety using adjustable magnetic forces. As a rule, the magnetic force is designed such that the workpiece cannot fall from the magnet even in unfavorable conditions, for instance when there are shocks, transverse forces, or the like.

It is relatively simple to lift workpieces that have a flat surface upon which a large surface area of the magnet can be placed. This is also true of thin sheet coils if these are lifted at one of the two end faces. The end face of the coiled sheet is largely flat. In accordance with the prior art, such magnets or a housing with a plurality of magnets arranged therein and that project slightly beyond both sides of the coil is used. This can ensure that individual turns of the coil do not telescope or even that the coil does not fall from the magnet due to continuous telescoping of the windings.

However, in such a thin sheet coil bearing it is not only coils whose winding axis is vertical that are lined up, but also horizontal coils, i.e. those coils that rest on their cylindrical exterior surface with the coil axis horizontal. Horizontal coils are conducted in this position into a continuous annealing system, while vertical coils with a vertical winding axis are transported into a hood-shaped annealing setup.

In order to be able to transport vertical and horizontal coils of different diameters and different widths using a single magnet, load-lifting magnets have been developed that have movable poles that can adapt to the shape of the coils. Using these magnetic poles that can move about their longitudinal axis, the ratio of nominal load to dead weight can be improved significantly. In one specific embodiment, four magnetic poles are arranged in a box, the sides and bottom of which are made of non-magnetic steel so as to get a higher magnetic flux at the poles. Windings made of aluminum make possible further savings in terms of weight.

However, it is still problematic when a thin sheet coil is not only to be lifted and transported, but also rotated by 90°. The available electromagnets cannot accomplish this, since the magnetic poles are arranged with their longitudinal axes in a horizontal plane when lifting and transporting.

Thus for turning a coil 90° additional turning apparatus is required that substantially increases the equipment and process technology complexity. Using tongs that grasp the coil and hold it securely at a certain height to turn a coil hanging on a magnet by 90° so that when the magnet is lowered the coil automatically pivots can lead to undesired damage to the surface of the coil.

In addition, after a 90° rotation a magnet placed on the end face of a coil is also subject to shear forces that can cause the coil to slip.

It is the object of the present invention to develop a load-lifting magnet of the type cited in the foregoing with which it is possible to rapidly and easily rotate a wound body in a suspended position without damaging this body.

This object is attained using a load-lifting magnet in accordance with claim 1.

In accordance with the invention, magnetic poles are arranged at right angles to each other on a common support body so that they can simultaneously hold one end face of the wound body as well as the surface. The support body has a rotating apparatus that permits 90° rotations of the wound body while it is suspended. According to the inventive idea, two electromagnets are thus used, of which one holds the flat end face and the other a cylindrical side surface of the body to be lifted. Although theoretically it would be possible for these two electromagnets to be suspended separately, this has the disadvantage of substantial complexity in terms of structure and/or process technology in order to be able to place both magnets securely. Since these electromagnets would each hang freely, care would also have to be taken to provide a space between them when they were lifted and lowered without a load, thus preventing the electromagnets from damaging each other. For this reason a support body is selected as attachment site for the two electromagnets, and it assures the desired position of the electromagnets spaced from each other and at right angles to each other. The support body itself is attached to a crane or a trolley in a manner known in accordance with the prior art.

Further developments of the inventive subject matter are described in the subordinate claims.

Thus the magnetic poles can preferably be operated by a controller such that first the magnetic poles can be activated for holding the end face of the wound body and then the other magnetic poles can be activated for holding the curved surface. This provides a sequence control that ensures that all of the magnetic poles are placed on the workpiece in the best possible manner.

Preferably the magnetic poles that are positioned against the surface of the wound body can be moved about their longitudinal axes. This movable arrangement of the magnetic poles creates, instead of simple linear contact, dual-line contact between adjacent magnetic poles and the surface, and furthermore air gaps, which represent a significant magnetic resistance, are clearly reduced because of this “separation.” This occurs because the exterior surface of a cross-section of a wound coil forms a circle. If the pole shoes are in a single plane, the magnet can only be placed upon it tangentially, which results in a point contact in cross-section and in linear contact in the spatial depth. On the other hand, if the pole shoes can be pivoted, such line contact with smaller air gaps is created on each side of the contact lines for each for two adjacent poles.

A further improvement is attained when each of the magnetic poles has a center groove so that the magnetic pole itself can hold the coil on its round surface in two-line contact.

In accordance with another embodiment of the invention, the magnetic poles provided for placement on the surface can also have rounded contact surfaces whose radius is the same size as the radius of the exterior surface of the largest wound body to be picked up. Coils with a large radius have a clearly higher weight than coils with a small radius; doubling the radius causes the weight to quadruple. In order to provide optimum contact for the heaviest coil, the surface curvature of the magnetic poles that are to be placed on the surface is adapted accordingly. While for a smaller radius there is again only linear contact, due to the curved magnetic pole contact surface the corresponding air gaps are relatively small, so that the substantially lower weight of the coil with the smaller radius can be held securely.

In order to be able to pick up different coil sizes, the magnetic poles that are to hold the coil at the curved cylindrical surface can be mounted so as to be displaceable on the support body in the radial direction of the body to be picked up. What this enables is that first the magnetic pole or the magnetic poles are placed on the flat coil end face and then the magnetic poles oriented perpendicular thereto are shifted radially until they make contact. The appropriate movement can be performed using the above-described sequence control that is also used for successively turning on the magnets.

In accordance with another embodiment of the invention, the support body has a traveling mandrel that can be inserted into coils to be picked up prior to lifting. This mandrel is moved in the direction of the winding axis of the coil and, after being inserted, establishes the position of the magnet or the magnetic poles that grip the coil end face. In particular the mandrel is passed through a throughgoing hole in the magnet, i.e. the effective magnetic poles are located on both sides of the mandrel. In the case of a wound coil, different interior diameters are possible, as a result of which the mandrel to be used is preferably embodied as a cone or as an expanding mandrel.

In order to be able to rotate the wound body 90° while it is suspended, on its outer side the support body has a chain or toothed rack in which a motor-operated sprocket or gear engages. This sprocket or gear is securely joined to the crane suspension so that the support body can be rotated 90° while suspended, such that the electromagnets that act perpendicular to each other hold the workpiece securely in each rotational position with the magnetic poles.

Wound bodies can have not only different interior and exterior radii, but also different widths. Using just the above-described measures it is possible to cover a large range of widths. In principle it is possible to use different support bodies with the electromagnets for smaller and narrower coils whose size is quite different from the largest and wider coils; in particular even smaller coils can be lifted by smaller crane systems due to their lower weight.

In accordance with a further development of the present invention, however, the magnetic poles are removably mounted on the support. In this manner the support bodies can remain with the rotating device on one and the same crane or trolley system, only the magnetic poles having to be exchanged when needed.

The present invention has the advantage that an integral load-lifting magnet has been created that permits the workpiece to be rotated while suspended without additional aids. This is of great significance in particular for wound thin sheet coils, which, depending on the subsequent treatment required, can be not only transported, but also can be easily rotated without risking damage. In particular substantial savings in terms of time can also be obtained with the inventive load-lifting magnet.

Additional advantages and variants can be found in the drawings.

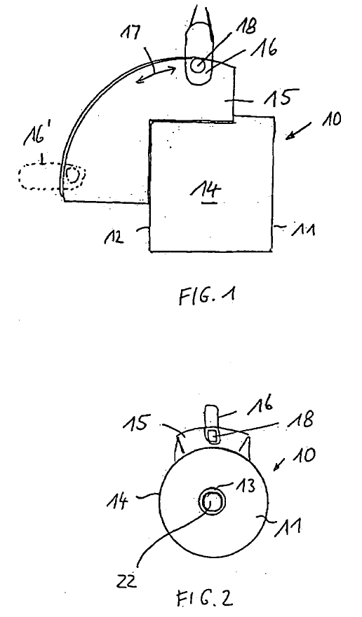

FIG. 1 is a basic side view of a load-lifting magnet with suspended coil;

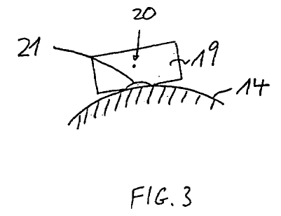

FIG. 2 is a side view of the apparatus in accordance with FIG. 1, offset by 90°; and

FIG. 3 is a pole shoe with a groove.

A wound coil 10 made of thin sheet has two flat end faces 11 and 12, a side surface 14 that has a circular cross-section, and a winding hole 13 that forms an inside radius. Load-lifting magnets can be used due to the ferromagnetic material that comprises the wound coil.

In accordance with the invention, a support body 15 carries a plurality of magnetic poles that can hold both the end face (end face 12 in FIG. 1) and the cylindrical side surface 14 simultaneously. In addition, the support body 15 has a rotating apparatus 16 that permits 90° rotations of the wound body while it is suspended. As can be seen from the sketch of FIG. 1, to accomplish this the suspended rotating apparatus 16 is moved along the double arrow 17. This can occur for instance by using a driven toothed wheel 18 in a chain or using a curved toothed rack. By moving the rotating apparatus 16 into the position shown at 16′, the support body 15, and thus the coil are pivoted 90° so that the coil can be picked up from a stand with its center axis horizontal, then pivoted through 90°, and then set down on its end face with its axis vertical.

The magnetic poles 19 (see FIG. 3) that hold the curved surface 14 can rock about their longitudinal axis 20. Preferably these magnetic poles 19 have a groove 21 that makes it possible for the magnetic poles 19, the contact surfaces of which are flat, to contact the surface at two lines. The air gap between the magnetic pole bottom and the surface 16 is kept relatively small.

In alternative embodiments (not shown), the contact surface of the magnetic poles that are to be placed on the cylinder surface are shaped to correspond to the cylinder radius of the largest coil to be picked up. The magnetic poles 19 that are to be placed on the surface 14 are preferably movably arranged in the support body 15 in a direction that corresponds to the radius a suspended coil. In this manner it is easily possible to move the support body by means of a crane or trolley to a coil that has been placed or set aside such that first the magnetic poles are positioned in contact with one of the end faces 11 or 12 and then they are activated. Then the other magnetic poles are activated by means of the available full control, where necessary after first being displaced radially. Secure magnetic fixing using this measure ensures exact alignment of the coil with respect to the support body, with all of the pole shoes positioned optimally. The coil can now be lifted, rotated, transported if necessary, and put down again.

In accordance with another embodiment illustrated in FIG. 2, the support body 15 has another mandrel 22 that can travel in the direction of the winding axis and that is first moved when the support body is positioned or when the magnetic poles are fixed magnetically to the coil surfaces and that is then inserted into the winding hole. In order to be able to handle different winding hole diameters, the mandrel can be made either as a cone or as an expanding mandrel. Such a mandrel also fixes the coil so that the magnets are prevented from “sliding” on one of the end faces.

1-10. (canceled)

11. A magnetic grab for lifting a coil having a generally planar end face and a generally cylindrical side face, the magnet comprising:
a support body;
two magnets carried on the support bodies and centered on respective pole axes extending generally perpendicular to each other such that one of the magnets can be engaged with one of the end faces of the coil and the other against the side face of the coil simultaneously; and
means for pivoting the support body through about 90° when the one magnet is clinging magnetically to the one end face and the other magnet to the side face.

12. The coil-lifting magnetic grab defined in claim 11, further comprising
control means for energizing the magnets electrically one substantially after the other.

13. The coil-lifting magnetic grab defined in claim 12 wherein the control means first energized the magnet engaging the one end face and then energizes the magnet engaging the side face.

14. The coil-lifting magnetic grab defined in claim 11 wherein the magnets can rock on the support about respective pivot axes generally perpendicular to the respective pole axes.

15. The coil-lifting magnetic grab defined in claim 11 wherein at least one of the magnets is formed with a central outwardly open groove for engagement with the coil at two offset lines flanking the groove.

16. The coil-lifting magnetic grab defined in claim 11 wherein at least one of the magnets has a curved coil-engaging face of a radius of curvature equal to that of the largest coil to be picked up by the grab.

17. The coil-lifting magnetic grab defined in claim 11, further comprising
means securing at least one of the magnets on the support for limited movement along the respective pole axis.

18. The coil-lifting magnetic grab defined in claim 11 wherein the means for shifting includes a toothed wheel.

19. The coil-lifting magnetic grab defined in claim 11, further comprising
a mandrel carried on the support body and engageable through a center of the coil engaged by the magnets.

20. The coil-lifting magnetic grab defined in claim 19 wherein the mandrel is expansible.

21. The coil-lifting magnetic grab defined in claim 11 wherein the magnets are removably mounted on support body.

22. The coil-lifting magnetic grab defined in claim 11 further comprising
electrical energizing means connected to zones of the magnets for controlling strengths of magnetic fields created by the magnets.
